(19) United States
(12) Patent Application Publication
(10) Pub. No.: US 2025/0372061 A1
(43) Pub. Date: Dec. 4, 2025

(54) LOCK SYSTEM AND METHOD FOR A FLOATING VIBRATO TAILPIECE

(71) Applicant: Ben Nuñez, Wolfforth, TX (US)

(72) Inventor: Ben Nuñez, Wolfforth, TX (US)

(21) Appl. No.: 19/219,976

(22) Filed: May 27, 2025

Related U.S. Application Data
(60) Provisional application No. 63/653,122, filed on May 29, 2024.

(51) Int. Cl. G10D 3/153; G10D 1/08

(52) U.S. Cl. CPC G10D 3/153; G10D 1/085

(57) ABSTRACT

A method of locking and unlocking a vibrato tailpiece assembly of a guitar that includes rotating a driveshaft of the vibrato tailpiece assembly to an ON configuration to lock the vibrato tailpiece assembly of the guitar and rotating the driveshaft to an OFF configuration to unlock the vibrato tailpiece assembly of the guitar.

### CROSS-REFERENCE TO RELATED APPLICATIONS

This application is a non-provisional of and claims the benefit of U.S. Provisional Application No. 63/653,122, filed May 29, 2024, entitled “LOCK SYSTEM AND METHOD FOR A FLOATING VIBRATO TAILPIECE,” with attorney docket number 0123462-001PR0. This application is hereby incorporated herein by reference in its entirety and for all purposes.

### BACKGROUND

A popular feature on modern electric guitars is a vibrato tailpiece assembly; also known erroneously as a tremolo system (“tremolo” refers to the modulation in amplitude of a sound whereas “vibrato” refers to the modulation in pitch of a sound).

A vibrato tailpiece assembly permits expressive pitch modulation by varying string tension through controlled rotation of the bridge/tailpiece unit about a pivot axis. The components can include a string anchor or “roll” bar, a pivot mechanism (knife-edge or bearing), a set of springs (or cams) that balance string tension, mounting posts or a hinged plate to the guitar body, and—on locking systems—string clamps and fine tuners. When the player manipulates the vibrato arm, the bridge rotates, changing the balance between string and spring forces, thereby raising or lowering pitch; upon release, the assembly returns precisely to its neutral position due to the equilibrium of these forces and low-friction pivots. Variations such as the Fender synchronized tremolo, Bigsby vibrato, and double-locking Floyd Rose system implement this principle with differing pivot geometries, spring arrangements, and locking features to optimize range, stability, and ease of installation.

The vibrato's string anchor can be a cylindrical “roll” bar or block in which strings wind or clamp. In vintage synchronized tremolos, each string rests in a saddle on the roll bar; in Bigsby-style units, the strings loop over a pivoting bar seated on low-friction needle bearings for smoother return-to-neutral action; in double-locking systems, individual string clamps at the bridge secure each string after the initial anchor point to eliminate slippage.

The entire bridge/tailpiece assembly pivots about either knife-edge studs or precision bearings. Fender's synchronized tremolo uses two or six knife-edge points that rock in recesses in the bridge plate, while Bigsby employs bushings and needle bearings to reduce wear. More advanced systems, like Floyd Rose, utilize hardened steel knife edges or ball bearings in conjunction with replaceable saddles to ensure a consistent pivot axis and minimal friction.

Opposing the pull of the strings, a cluster of steel springs anchored to a “claw” plate counters string tension. In Fender-style bridges the springs attach via a claw screwed into the body; in Floyd Rose units, the springs and claw form a unit that threads into the body cavity. The number and dimensions of springs determine the counter-force, establishing an equilibrium where the bridge floats level when no vibrato force is applied.

Locking vibrato tailpieces can incorporate clamps at the nut and bridge to prevent string slippage through the tuning machines. Fine tuners, integrated into the bridge block, allow micro-adjustment of pitch without unlocking. These features, pioneered in the Floyd Rose design, can enhance tuning stability under extreme pitch bends by maintaining constant string length at the anchor points.

When the player pushes the vibrato arm downwards, the bridge rotates counter-clockwise (viewed from above), reducing string tension and flattening pitch; correspondingly, the springs stretch, storing potential energy. Pulling the arm upward rotates the bridge clockwise, increasing string tension and sharpening pitch, while compressing the springs. Upon release, the balanced forces and low-friction pivot cause the bridge to return exactly to its neutral position, restoring original string tension and tuning.

For accurate return, the elimination of play in contact points can be desirable. Knife edges must seat cleanly, springs must have consistent attachment, and string clamps must secure the string without slippage. Low-friction bearings in Bigsby units and hardened edges in Floyd Rose systems both serve to minimize hysteresis. Proper setup (e.g., ensuring the bridge plate is parallel to the body and spring tension balances string pull) can be desirable for precise centering.

Variations of vibrato tailpiece assemblies include the Fender Synchronized Tremolo, which was invented in the 1950s. This design uses six screws as pivot studs and three springs in a rear cavity; it offers moderate range and straightforward installation but limited upward pitch bend due to body contact. Another variation is the Bigsby Vibrato, which includes a pivoting string bar on needle bearings and a tension spring, offering subtle vibrato with smooth return but limited range. It mounts on the guitar's top via a hinged plate secured by screws or an adapter. Another variation includes the Floyd Rose Double-Locking Tremolo, which can be a fully floating system that locks strings at both the nut and bridge, uses a hardened steel block and replaceable edge saddles for pivoting, and features fine tuners on the bridge.

Existing vibrato tailpiece assemblies, such as those found on Fender, Floyd Rose, and Bigsby systems, inherently suffer from resonance deficiencies. In these designs, the counter-tension springs required to balance string tension absorb a significant portion of the vibrational energy, which can prevent the full transfer of mechanical energy from the strings to the guitar body. This absorption not only undermines overall acoustic volume and sustain but also contributes to a muted tonal quality in the instrument's output.

Additionally, the floating mechanism introduces several operational challenges. When a guitarist bends a single string to change pitch, the balanced tension system causes the remaining strings to lose tension, leading to unintended pitch shifts and requiring a greater bending distance compared to fixed-bridge systems. The delicate balance between the total string tension and the counter-tension springs further complicates tuning, making stability difficult to maintain. Moreover, the system's high sensitivity means that even slight pressure on the bridge or aggressive playing can introduce flutter, chirp, or irregular pitch variations. Finally, instances of string breakage disrupt the established equilibrium, resulting in disproportionate pitch changes across the remaining strings and making it impossible to restore proper tuning without major disruption while playing.

In view of the foregoing, a need exists for an improved vibrato tailpiece system and method in an effort to overcome the aforementioned obstacles and deficiencies of conventional vibrato tailpiece systems.

### BRIEF DESCRIPTION OF THE DRAWINGS

FIG. 1 illustrates a front face of a guitar that includes a driveshaft of a vibrato tailpiece system.

FIG. 2 illustrates a rear face of a guitar that includes a vibrato tailpiece system disposed within and coupled within a cavity of the guitar.

FIG. 3a is a cross-sectional side view of a vibrato tailpiece system coupled to the body of a guitar and in an “OFF” configuration.

FIG. 3b is a close-up side view of the circled portion of FIG. 3a illustrating the vibrato tailpiece system in the “OFF” configuration.

FIG. 4a is a cross-sectional side view of a vibrato tailpiece system coupled to the body of a guitar and in an “ON” configuration.

FIG. 4b is a close-up side view of the circled portion of FIG. 4a illustrating the vibrato tailpiece system in the “ON” configuration.

FIG. 5a is a perspective view of a vibrato tailpiece system in an “OFF” configuration.

FIG. 5b is a perspective view of the vibrato tailpiece system of FIG. 5a in an “ON” configuration.

FIG. 6a is a top view of a vibrato tailpiece system in an “OFF” configuration.

FIG. 6b is a closeup view of a portion of the vibrato tailpiece system of FIG. 6a.

FIG. 6c is a top view of the vibrato tailpiece system of FIG. 6a in an “ON” configuration.

FIG. 6d is a closeup view of a portion of the vibrato tailpiece system of FIG. 6c.

FIG. 7 is a side view of a latch assembly in accordance with an embodiment.

FIG. 8a is a top perspective view of the latch assembly of FIG. 7.

FIG. 8b is a bottom perspective view of the latch assembly of FIGS. 7 and 8a.

FIG. 9 is a side view of a latch assembly in accordance with another embodiment.

FIG. 10a is a top perspective view of the latch assembly of FIG. 9.

FIG. 10b is a bottom perspective view of the latch assembly of FIGS. 9 and 10a.

FIG. 11a is a first perspective view of a block assembly in accordance with an embodiment.

FIG. 11b is a second perspective view of a block assembly of FIG. 11a.

FIG. 12 is a cross-sectional view of a block assembly in accordance with an embodiment.

FIG. 13a is a first perspective view of a block assembly in accordance with another embodiment.

FIG. 13b is a second perspective view of a block assembly of FIG. 13a.

FIG. 14 is a cross-sectional side view of a block assembly in accordance with an embodiment.

FIG. 15a is a first cross-sectional side view of a block assembly in accordance with an embodiment.

FIG. 15b is a second cross-sectional side view of the block assembly of FIG. 15a.

FIG. 16a is a perspective view of a driveshaft in accordance with an embodiment.

FIG. 16b is a perspective view of a driveshaft in accordance with another embodiment.

FIG. 17a is a first perspective view of a transmission in accordance with an embodiment.

FIG. 17b is a second perspective view of a transmission of FIG. 17a.

FIG. 17c is a top view of the transmission of FIGS. 17a and 17b.

FIG. 18a is a first perspective view of a transmission in accordance with another embodiment.

FIG. 18b is a second perspective view of a transmission of FIG. 18a.

FIG. 18c is a top view of the transmission of FIGS. 18a and 18b.

FIG. 19a is a side view of a transmission bolt and base unit in an “OFF” configuration in accordance with an embodiment.

FIG. 19b is a first perspective view of the transmission bolt and base unit of FIG. 19a.

FIG. 19c is a second perspective view of the transmission bolt and base unit of FIGS. 19a and 19b.

FIG. 20a is a side view of a transmission bolt and base unit in an “ON” configuration in accordance with another embodiment.

FIG. 20b is a first perspective view of the transmission bolt and base unit of FIG. 20a.

FIG. 20c is a second perspective view of the transmission bolt and base unit of FIGS. 20a and 20b.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION

The one aspect of the present disclosure provides a mechanism that transforms a conventional floating vibrato tailpiece, a system commonly used on electric guitars to modulate pitch, into a stable fixed-bridge configuration with a simple repositioning of the vibrato arm. By incorporating a driveshaft and transmission assembly, along with interlocking bolt and latch components, the system effectively locks the tailpiece in place, bypassing the counter-tension springs that can dampen resonance and compromise tuning stability. This conversion can address several challenges inherent to floating systems, such as unwanted pitch variations during string bending, difficulty in maintaining proper tuning after string breakage, and issues with string sagging.

Furthermore, various embodiments are suitable for use with various vibrato systems including those found on Fender, Floyd Rose, and Bigsby guitars. The ease of switching between floating and fixed modes in various embodiments not only enhances acoustic volume, sustain, and overall performance but also simplifies string changes and in-situ tuning adjustments. This can result in a more reliable and versatile playing experience, significantly reducing the downtime and performance disruptions typically associated with conventional floating vibrato tailpiece systems.

There can be several different design architectures for vibrato tailpieces. Various embodiments discussed herein relate to a style of vibrato tailpiece that equalizes the tension of the strings on the guitar with counter-tension springs within a cavity in a guitar body (e.g., Fender, Floyd Rose, or the like) and/or a single counter-tension spring located between a moving mechanism or “crank” that can be relational to the strings and a stationary base in some examples (e.g., Bigsby, or the like). Both the strings and springs in various embodiments are attached to an assembly that pivots on a fulcrum. The pivoting assembly in various examples is only in contact with the fulcrum, strings, counter-tension springs and/or a handlebar or arm that receives input from the user. When properly adjusted, the state of the vibrato tailpiece can be described as “floating.” With a floating vibrato tailpiece, in various embodiments, the user can add or remove length to the string that adds or removes tension from the strings by pushing or pulling the arm toward or away from the body of the guitar resulting in the lowering or raising of the pitch of the strings to the user's musical desire or as otherwise necessary or desirable.

There can be four properties of a string that makes it possible to produce different pitches from the same string: Length, tension, diameter and density. Diameter and density can be static values for the life of the strings, while length and tension can be adjustable in real-time in various examples. A floating vibrato tailpiece can be highly responsive to user input in various embodiments, allowing for the creation of innumerable, unique pitch variations.

However, a floating vibrato tailpiece assembly can have several disadvantages. For example, the basic architecture of some examples of a floating vibrato tailpiece assembly (e.g., Fender or Floyd Rose) can disallow the total amount of vibrational energy from the strings to transfer to the guitar, which can result in a loss of resonance. Additionally, because in various examples the tension is balanced between the strings and counter-tension springs, any addition of tension to a string by the fretting hand by a manual bend to raise its pitch can result in a lowering of pitch of all other strings.

Also, the physical distance that a single string must be bent to reach a desired pitch can be significantly more than a guitar with a fixed-bridge system. Because of the lowering of pitch or “sagging” of the unbent strings during a string bend in various embodiments, the learned skill of bending a string to a specific pitch can be significantly different between a floating vibrato tailpiece system and a fixed-bridge system. This difference may not be easily overcome when a musician switches between these two systems.

In another example, the behavior of a floating vibrato tailpiece assembly relative to string tension balancing against the counter-tension spring(s) can also greatly multiply the difficulty in tuning the guitar. The total tension of all the strings will equal “X,” for example. The total tension from all the counter-tension spring(s) will equal a static value of “Y,” for example. In a properly adjusted system of various examples, the floating bridge assembly's frame or crank can be set to its “origin” position of “Z”. “X” must equal “Y” in various embodiments when “Z” is at origin for system balance. The nature of a Fender and Floyd Rose floating vibrato tailpiece system can also change the length of each string. This can be another factor to the raising and lowering of pitch for each string relative to its tension. As the vibrato tailpiece is moved by the user input of the arm, this can change “Z” and can shorten or lengthen the strings resulting in the lowering or raising of string tension (e.g., Fender & Floyd Rose) or only reducing the string tension (e.g., Bigsby) resulting in the lowering or raising of the pitch of the strings to the user's musical desire or as otherwise necessary or desirable. When adjusting the tuning of a single string, tension can be added or subtracted to “X” in various examples to reach the desired pitch, resulting in a change to “Z”, resulting in a reduction or increase of length of the strings, resulting in a lowering or raising of pitch of the other strings. Inevitably, in various examples, all strings must be adjusted to meet proper tuning. This can bring “X” back to its original value of being in balance with “Y” when “Z” is at origin.

Additionally, any of the strings can occasionally break resulting in various embodiments in an imbalance of tension between the remaining strings (“X”) and counter-tension spring(s) (“Y”). Because there is now less tension from the remaining strings, the counter-tension springs pull the assembly (“Z”) lengthening all remaining strings (e.g., Fender & Floyd Rose) or it rotates the crank (e.g., Bigsby) causing the pitch to significantly and disproportionately raise from a properly tuned guitar. Because of this massive pitch irregularity, when a string breaks, the guitar of various examples can become impossible to continue playing in the same tuning as before the string breaking.

Also, if a player applies too much pressure by resting the palm of their picking hand on the floating bridge system (e.g., Fender & Floyd Rose), in various examples it can make the pitch of all the strings go up. Additionally, a firm attack on the strings by the plectrum or fingers on the strings during performance can also produce a flutter or chirp from the floating system of various examples that accompanies the sound from the string(s). Furthermore, an adjustment to an alternate tuning is virtually impossible with a fully floating system in various embodiments without adjusting the counter-tension springs with a tool (e.g., Fender & Floyd Rose).

Accordingly, various embodiments discussed herein related to an improved vibrato tailpiece system and method for changing the state of a system from a floating vibrato tailpiece system to a fixed-bridge system, which in some embodiments can overcome one or more of the aforementioned obstacles and deficiencies of conventional floating vibrato tailpiece systems.

The function of various embodiments disclosed herein can be to change the state of an unencumbered, movable, floating vibrato tailpiece assembly system to an immovable, fixed-bridge system with a simple, rotational repositioning of the vibrato arm that is part of a mechanism that locks the floating vibrato tailpiece assembly. Regardless of the number of strings, gauge of strings and type of instrument, the various embodiments disclosed herein can be for a floating vibrato tailpiece. Various embodiments change the state of the vibrato tailpiece assembly system from floating to fixed (e.g., Floyd Rose, Fender, or the like). For various Bigsby-style vibrato tailpiece systems, and the like, the bolt can act as a nut. The stock arm in various embodiments can now act as a driveshaft/transmission that rotates the bolt in and out of the latch.

For various Fender & Floyd Rose-style systems, and the like, the stock arm can be replaced by a replacement arm as disclosed herein in various embodiments. In some embodiments, a stock arm is incompatible with a replacement system discussed herein and a replacement arm is necessary for the replacement system to work. The arm in some examples can be available in different shapes for a more ergonomically correct fit for the user's hand and/or for surface component clearance. The arm can act as a driveshaft in various embodiments as discussed herein.

With the arm/driveshaft inserted into the transmission and secured with a collet nut, in various embodiments, moving the arm/driveshaft parallel to the surface of the guitar rotates the entire transmission assembly with it. The arm/driveshaft, collet and/or collet nut assembly can be visible above the frame of the vibrato bridge assembly in various examples. Underneath the frame of the vibrato bridge assembly can be a cam section of the rotating transmission. The cam shape in various embodiments can be truncated from a full elliptical shape of some examples, for clearance within the guitar cavity during use of the vibrato tailpiece.

Being that the function of various embodiments can be to lock the state of an unencumbered, movable, floating vibrato tailpiece system to an immovable, fixed-bridge system with a rotational repositioning of the arm from “OFF” to “ON”, the advantages of various examples can be numerous.

In various examples, mechanical energy moves from a guitarist's plectrum or fingers then into the strings of the guitar. Energy can then pass simultaneously to the nut/frets/neck, move into the bridge assembly, into the fulcrum and into the body of the guitar. The bridge assembly in various embodiments also passes energy into the counter-tension springs, into a claw that holds the other end of counter-tension springs, into the (e.g., two) screws that hold the claw and into the guitar body. Eventually, some or all available mechanical energy returns back to the strings. This synchronous vibration of the guitar body can reinforce the original vibration of the string to produce resonance.

The problem with various examples of floating vibrato tailpieces can be that the counter-tension springs can absorb a significant portion of this overall vibrational energy; the nature of a spring can be to absorb. The latch assembly of various embodiments discussed herein can bypass the counter-tension springs with a firm connection from the bridge assembly directly to the body, resulting in a noticeable improvement to acoustic volume and sustain of the strings like a fixed-bridge assembly.

When guitarists stop using or touching the vibrato arm in various embodiments, it can naturally or always be moved out of the way to focus on foundational methods of playing guitar such as using a plectrum or fingers to access all strings. This “non-use” position can be the “ON” position of various embodiments, which can be desirable in various examples because such a position can provide the most natural activation possible.

Removal of old strings can remove the opposing tension to counter-tension springs. This can cause the bridge assembly to be pulled significantly out of normal operating position (“Z”), resulting in a tilting or squatting in various embodiments. The effort to physically replace the strings is only marginally affected in various examples. However, bringing such new strings to proper pitch can be a major struggle in various embodiments. With the relationship of the counter-tension spring(s) against the collective amount of tension of all strings of some examples in mind, as tension and pitch are raised to an individual string during tuning, the tension and pitch of all other strings can (e.g., slightly) fall. Regardless of the fact that overall tension is added to the string side of the equation, tension resulting in pitch can be randomly shared across all strings.

As more and more tension is added to the strings to bring them up to proper pitch, in various embodiments this counter-intuitive effect of tuning diminishes as the overall tension is matched with the counter-tension springs. With tension in balance, the bridge assembly in various examples is back in the proper position of being parallel to the surface of the guitar. When various embodiments disclosed herein are in an “ON” configuration, a top bolt of a block assembly can be secured into a coupling hole in a latch assembly, or the bolt can rotate into the latch. This can (e.g., completely) lock and immobilize a portion of or the entire bridge assembly in various embodiments, which can neutralize the counter-tension spring(s).

The guitar in such a configuration can be in a fixed-bridge state in accordance with various embodiments. In such a configuration, and in various embodiments, the guitar can be easily re-strung without the hinderance of string tension balancing and the bridge assembly being out of the normal operating position. As each string is replaced, stretched and tuned, the bridge assembly can be kept (e.g., perfectly) stable when the various embodiments disclosed herein are in an “ON” configuration. When (e.g., all) strings are tuned as before and the embodiment is in the “OFF” position, the bridge assembly of various embodiments can remain in the identical position where “Z” is in its origin position. In various embodiments (and in some examples assuming that the replacement strings are exactly the same specifications as the ones that they are replacing), “X” will equal “Y” and “Z” will be at its origin position for system balance.

When various embodiments are in an “ON” configuration and in the fixed-bridge state, one or more disadvantages of a floating vibrato bridge system as discussed herein can be alleviated. For example, various embodiments can provide for the absence of string sag while bending. In another example, various embodiments can provide for no or reduced chirping and/or flutter when playing aggressively. In a further example, in various embodiments, alternate tunings are only limited to the travel of fine tuners on locked-nut systems if the guitar has that type of system.

In yet another example, various embodiments do not alter or substantially alter the feel or action of a floating vibrato tailpiece system. However, in some embodiments, there can be a limitation to the rotational range of the arm/driveshaft (e.g., of ≈100° of the arm/driveshaft) without body cavity modification of a stock guitar or other customization of a guitar.

One advantage of various embodiments can be the recovery and/or maintaining of proper tuning of remaining strings after a string breakage.

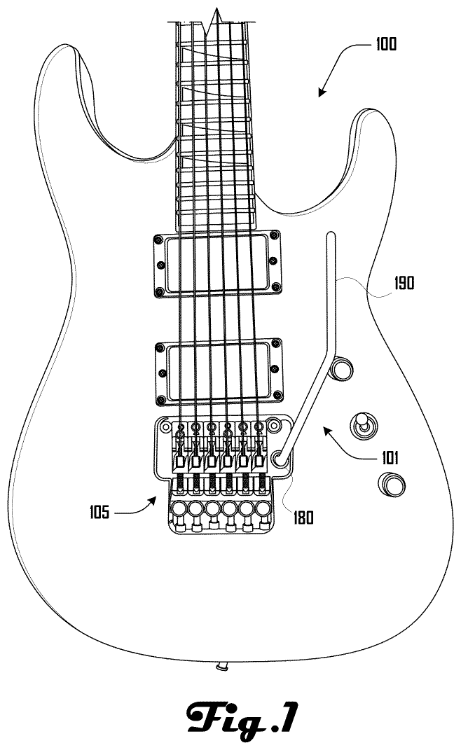

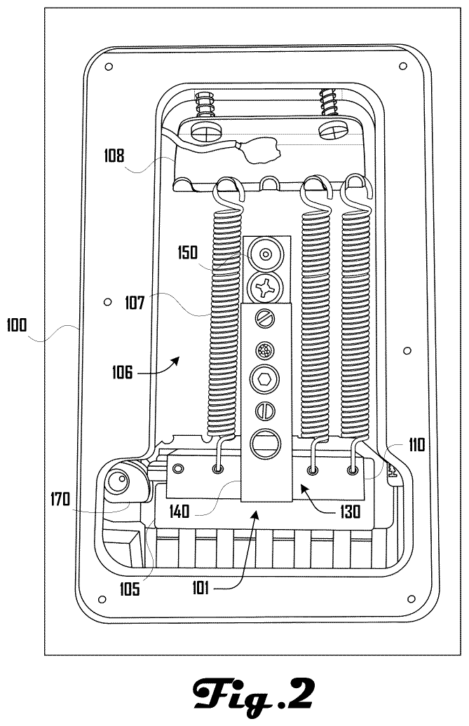

Turning to the Figures, embodiments of a vibrato tailpiece system 101 are illustrated, including FIGS. 1, 2 and 3a, which illustrate example embodiments of a vibrato tailpiece system 101 coupled to a guitar 100. As shown in FIGS. 1 and 2, the guitar 100 can include a bridge assembly 105 on a front face of the guitar 100, with a rear face of the guitar 100 defining a slot 106 where the vibrato tailpiece system 101 is disposed at least in part. The vibrato tailpiece system 101 in this example comprises a block assembly 110, and a latch assembly 130 that includes a latch 140 and a latch base 150. The vibrato tailpiece system 101 further comprises a transmission 170 that is coupled to a collet nut 180 and driveshaft 190 that extend from the front face of the guitar 100. A plurality of springs 107 can be coupled to the block assembly 110, with the springs 107 extending to and coupling with a claw 108.

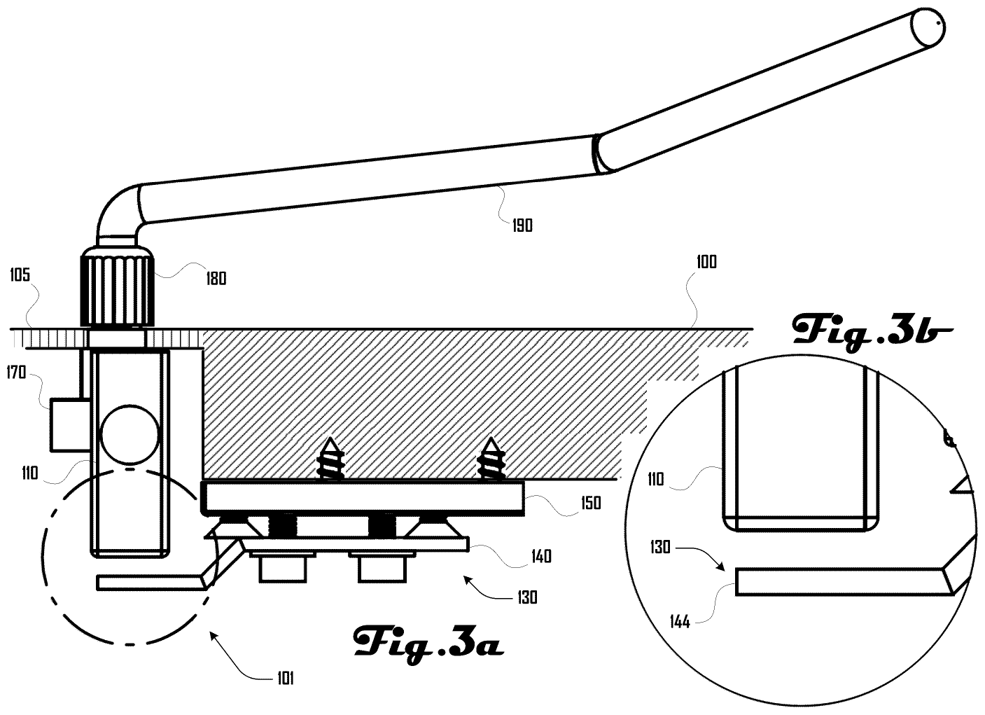

Turning to FIGS. 3a-20c, various embodiments of various parts of a vibrato tailpiece system 101 are illustrated in various configurations. For example, as discussed herein, in various embodiments, the vibrato tailpiece system 101 in this example comprises a block assembly 110, and a latch assembly 130 that includes a latch 140 and a latch base 150. The vibrato tailpiece system 101 can further comprise a transmission 170 that is coupled to a collet nut 180 and a driveshaft 190.

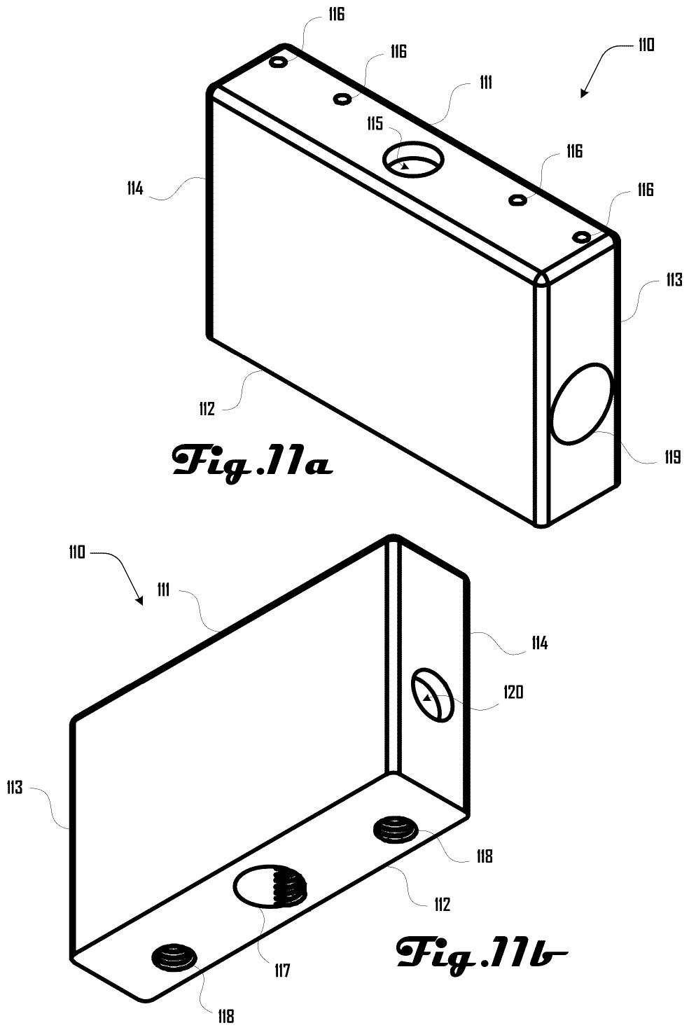

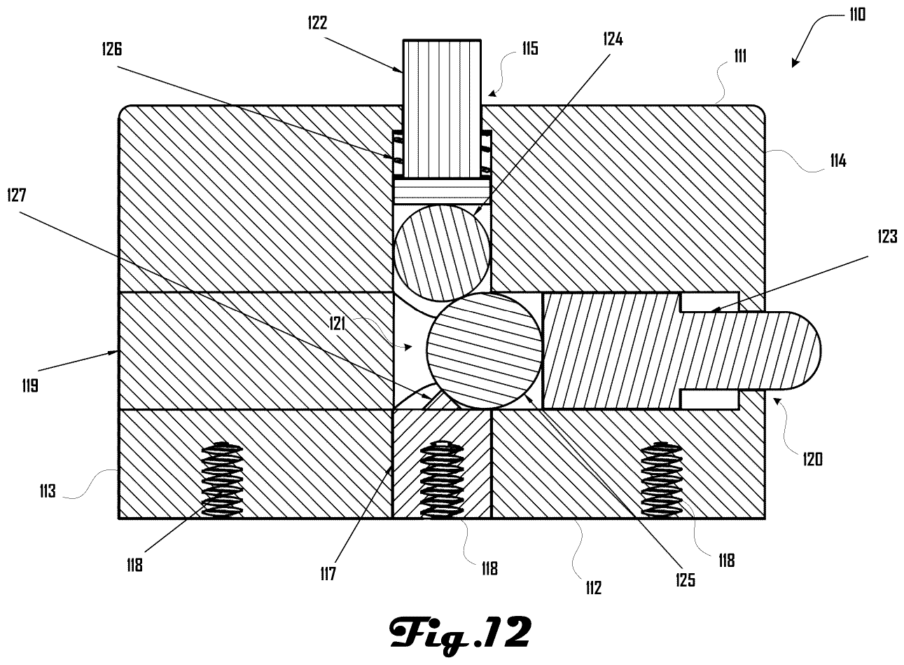

As shown in various examples, such as FIGS. 11a, 11b and 12, the block assembly 110 can comprise a top 111, a bottom 112 and a first and second side 113, 114. The top 111 of the block assembly 110 can comprise a top bolt opening 115 and a plurality of spring holes 116. The bottom 112 of the block assembly 110 can comprise a bottom plug 117 and a plurality of mounting holes 118. The first side 113 can comprise a side plug 119 and the second side 114 can comprise a side bolt opening 120.

As shown in the example embodiment of FIG. 12, the block assembly 110 can define an L-shaped block cavity 121 in which a top bolt 122, a side bolt 123, a top bolt bearing 124 and a side bolt bearing 125 movably reside. In various embodiments, the top bolt 122 can be biased via a top bolt spring 126. In some embodiments, the block assembly 110 can include one or more protrusions of channels within the block cavity 121 such as a bearing pathway obstruction 127.

In various embodiments, the block assembly 110 can have a generally rectangular cuboid shape, with the top 111 and bottom 112 defining parallel faces and the first and second sides 113, 114 defining parallel faces that are perpendicular to the faces of the top 111 and bottom 112. The block assembly 110 can comprise various suitable materials such as metal, plastic, wood, or the like.

Also, while specific example embodiments are shown and discussed herein, these examples should not be construed as being limiting. For example, some embodiments can have any suitable number of spring holes 116 (e.g., 1, 2, 3, 4, 5, 6, 7, 8, 9, 10, 15, 20, or the like, or a range between such example values). Also, some embodiments can have any suitable number of mounting holes 118 (e.g., 1, 2, 3, 4, 5, 6, 7, 8, 9, 10, 15, 20, or the like, or a range between such example values).

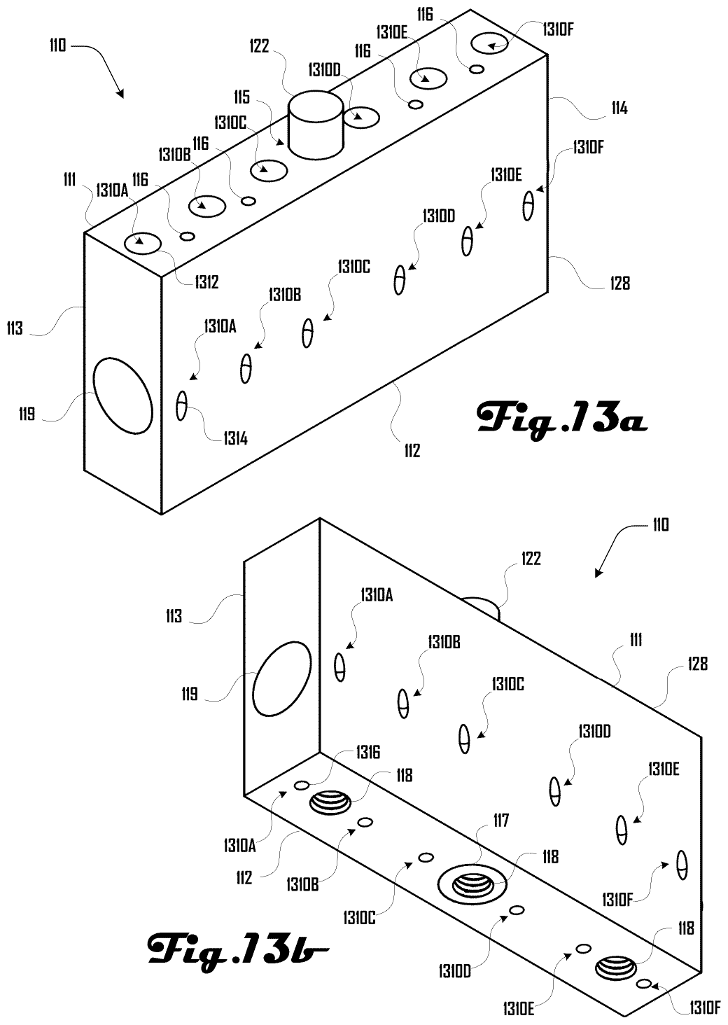

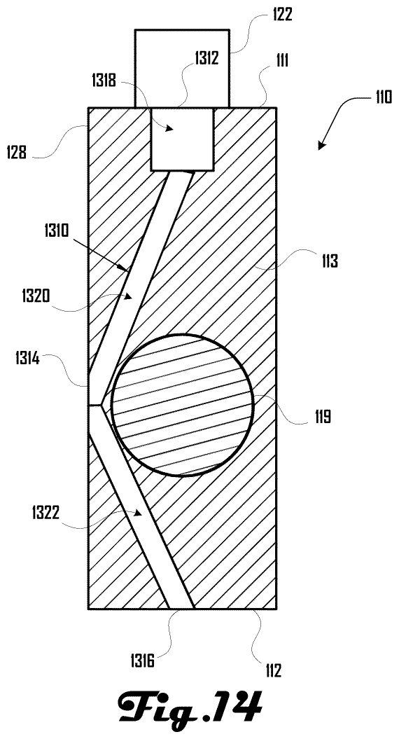

Additionally, in some embodiments, a block assembly 110 can comprise a plurality of string pathways 1310 as shown in the examples of FIGS. 13a, 13b and 14. For example, FIGS. 13a and 13b illustrate example embodiments where a block assembly 110 comprises six string pathways 1310A, 1310B, 1310C, 1310D, 1310E, 1310F which include a respective top opening 1312 on the top 111 of the block assembly 110; a respective front face opening 1314 on a front face 128 of the block assembly 110; and a respective bottom opening 1316 on the bottom 112 of the block assembly 110. As shown in the example cross-section of FIG. 14, in some embodiments a string pathway can be defined by top port 1318, a first chamber 1320, and a second chamber 1322. Some embodiments can have any suitable number of string pathways 1310 (e.g., 1, 2, 3, 4, 5, 6, 7, 8, 9, 10, 11, 12, 13, 14, 15, 20, 24, 50, 100 or the like, or a range between such example values).

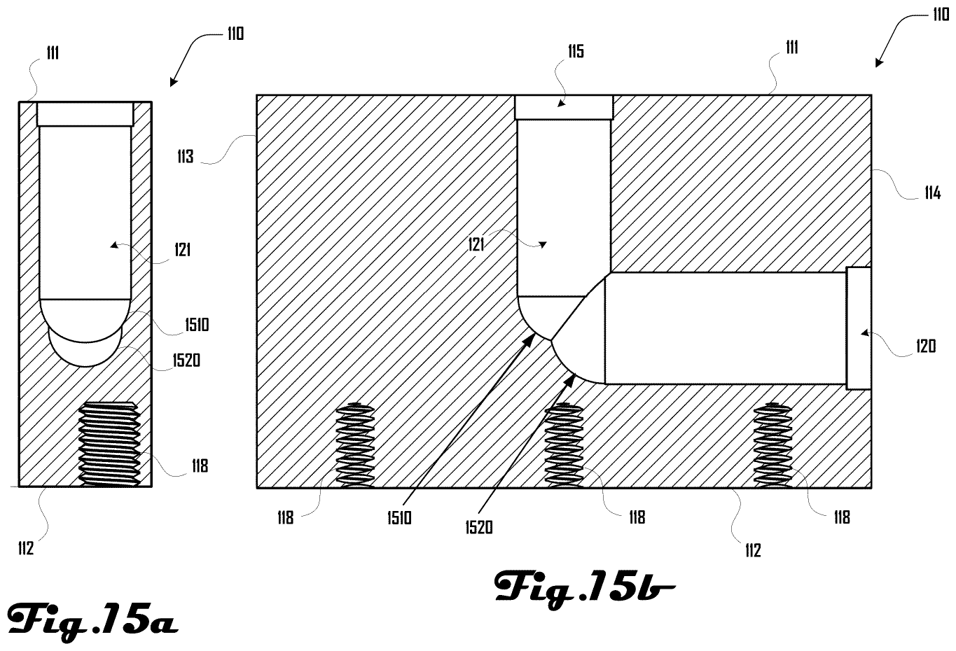

Additionally, while some embodiments include side and/or bottom plugs 117, 119 (e.g., for simplifying milling of a block assembly 110 or for other suitable purposes), in various examples, such plugs 117, 119 can be absent. For example, FIGS. 15a and 15b illustrate an example of a block assembly 110 where side and bottom plugs 117, 119 are absent. Additionally, in this example, the block cavity 121 is shown being L-shaped with contours 1510, 1520, which in various embodiments can be configured to correspond to the shape and/or size of one or more bearing 124, 125 (see e.g., FIG. 12).

Additionally, while various embodiments can comprise a block assembly 110 having bolt assembly comprising bolts 122, 123 and bearings 124, 125 that movably reside within the block cavity 121 and operate as further described herein, it should be clear that such examples of a bolt assembly should not be construed as limiting and any suitable configuration of a bolt assembly that operates as discussed herein, or the like, can be present in further embodiments. Also, further embodiments can include any other suitable mechanism for a block configured to operate as or similar to the mechanism(s) discussed herein.

In some embodiments, the block assembly 110 can be configured to hold the strings of a guitar 100. For example, FIGS. 13a, 13b and 14 illustrate example embodiments of a block assembly that comprises a plurality of string pathways 1310, with the example of FIGS. 13a and 13b including six string pathways 1310A, 1310B, 1310C, 1310D, 1310E, 1310F. In various embodiments, such as shown in FIG. 14, one or more string pathways 1310 can be defined by the block assembly 110, including extending from a top hole 1312 at the top end 111 to a side hole 1314 on a front side 128 and to a bottom hole 1316 on the bottom end 112. One or more string pathways 1310 can be defined by a top cavity 1318 that extends to a side hole 1314 via a first channel 1320 and then from the side hole 1314 to the bottom hole 1316 via a second channel 1322. In various embodiments, one or more guitar strings can be passed through and coupled within the block assembly 110 by passing the strings into the bottom hole 1316, through to the side hole 1314 and through to and out the top hole 1312. While some embodiments can include six string pathways 1310, further embodiments can include any suitable number of string pathways 1310 including 1, 2, 3, 4, 5, 6, 7, 8, 9, 10, 11, 12, 14, 16, 18, 20, 24, 36, 48, or the like or a range between such example values.

A latch assembly 130 can be configured in various suitable ways in accordance with various embodiments. For example, FIGS. 3a, 4a, 5a, 5b, 6a, 6c, 7, 8a and 8b illustrate one example embodiment of a latch assembly 130.

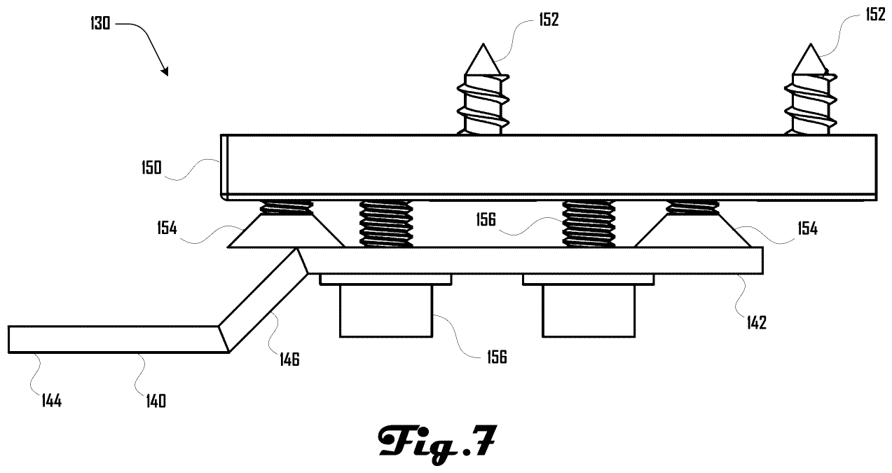

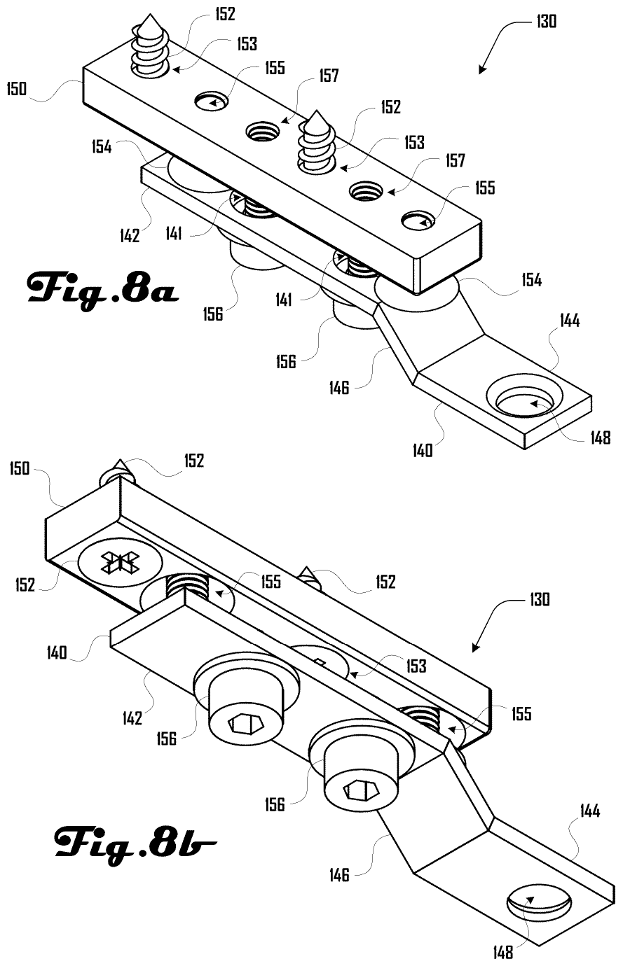

As shown in the examples of FIGS. 7, 8a and 8b a latch assembly 130 can include a latch 140 and a latch base 150. In this example, the latch base 150 comprises a pair of screws 152 that extend through respective screw holes 153 defined by the latch base 150. The latch base 150 further comprises two height adjustment bolts 154 that extend within respective height adjustment bolt holes 155 defined by the latch base 150. The latch base 150 further comprises two set bolts 156 that extend into respective latch base set bolt holes 157 defined by the latch base 150 and through respective latch set bolt holes 141 defined by the latch 140.

The latch 140 in this example is defined by a latch bar 142 at a first end and a receiver end 144 at a second end with a latch arm 146 connecting the latch bar 142 and the receiver end 144. The latch 140 further defines a coupling hole 148 at the receiver end 144.

In various embodiments, the latch assembly 130 can be configured to couple with the body of a guitar 100 within the cavity 106 on the back of the guitar 100 (see e.g., FIG. 2), via the screws 152 of the latch base 150 (see e.g., FIG. 3). The latch assembly 130 can comprise an adjustment mechanism (e.g., comprising one or more height adjustment bolts 154 and/or one or more set bolts 156), which can be configured to adjust the position of the latch 140 relative to the latch base 150, which can allow for adjustment of the position of the coupling hole 148 (e.g., height, distance and/or angle relative to the body of the guitar 100, latch base 150, and the like). As discussed in more detail herein, fine-tuning of the position/location of the coupling hole 148 can be desirable in various embodiments for aligning the coupling hole 148 with top bolt 122 of the block assembly 110 such that the coupling hole 148 and top bolt 122 can suitably couple as discussed in more detail herein.

For example, in some embodiments, a user can change the distance that one or more height adjustment bolts 154 extends from a top face of the latch base 150 (e.g., by rotating the height adjustment bolt(s) 154 via a screwdriver or hex wrench). The latch 140 can be positioned on the height adjustment bolt(s) 154 and coupled to the latch base 150 via one or more set bolts 156 and securely coupled against the top(s) of the height adjustment bolt(s) 154 by tightening the one or more set bolts 156 (e.g., by rotating the set bolt(s) 156 via a screwdriver or hex wrench).

While various specific examples of embodiments of coupling a latch assembly 130 to the body of a guitar 100 and an adjustment mechanism of a latch assembly 130 are shown herein, it should be clear that various suitable adjustment mechanisms for adjusting the position/location of the coupling hole 148 are within the scope and spirit of the present disclosure.

For example, while various embodiments include coupling a latch assembly 130 to a guitar 100 via one or more screws 152, in some embodiments a latch assembly 130 can be coupled to a guitar 100 in various suitable ways, including via one or more bolts, adhesive, welding, dowels, or the like. Additionally, while an adjustment mechanism of a latch assembly 130 can comprise bolts, screws, and the like, it should be clear that an adjustment mechanism can include any suitable elements in some embodiments, such as one or more slots, rails, a pivot, hinge, wedge, block, scissor mechanism, a telescoping element, a nested element, or the like.

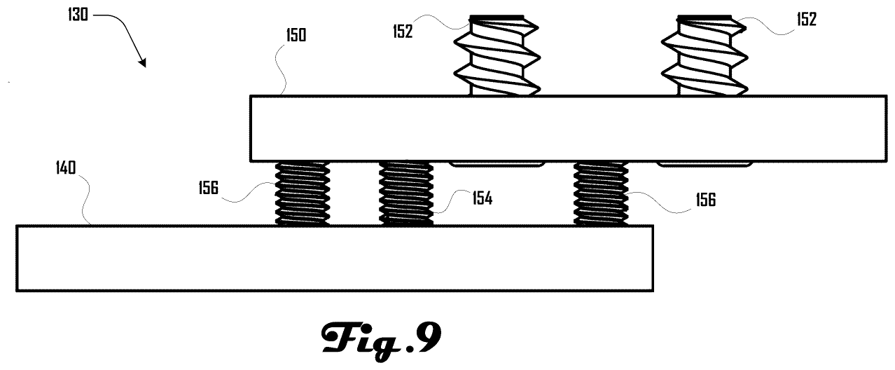

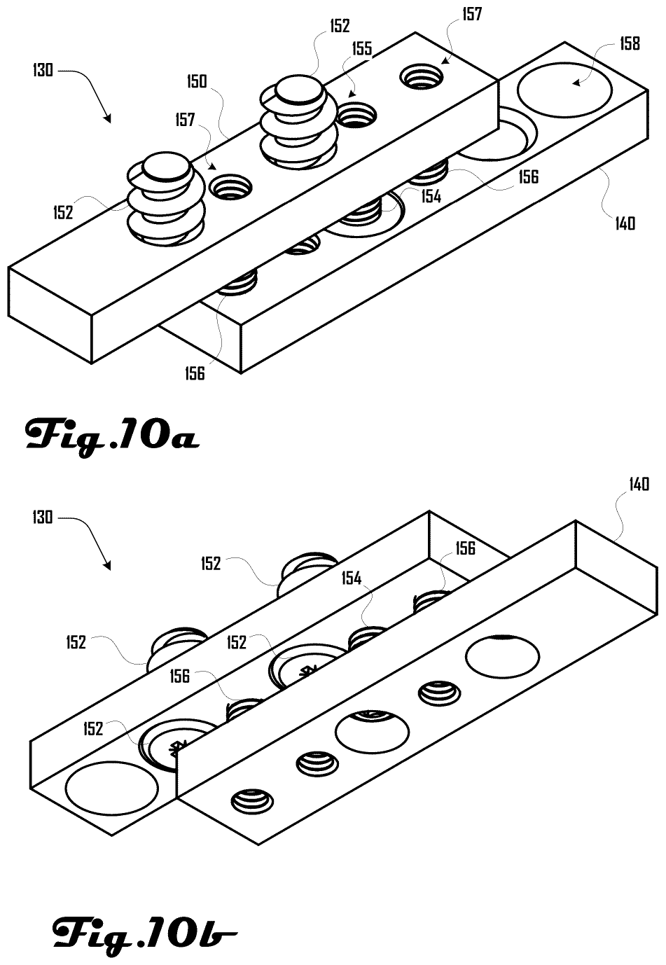

Also, while various examples illustrate the latch 140 and/or latch base 150 being of a planar cuboid shape or comprising planar cuboid sections, it should be clear that the latch 140 and latch base 150 can be configured and shaped in various suitable ways. For example, FIGS. 9, 10a and 10b illustrate another embodiment of a latch assembly 130 wherein both the latch 140 and latch base 150 are planar cuboid elements. In some embodiments, the latch 140 and latch base 150 can be identical or nearly identical elements, which may be desirable for ease in manufacturing. Additionally, the latch assembly 130 and elements thereof can comprise various suitable materials including metal, plastic, wood, and the like.

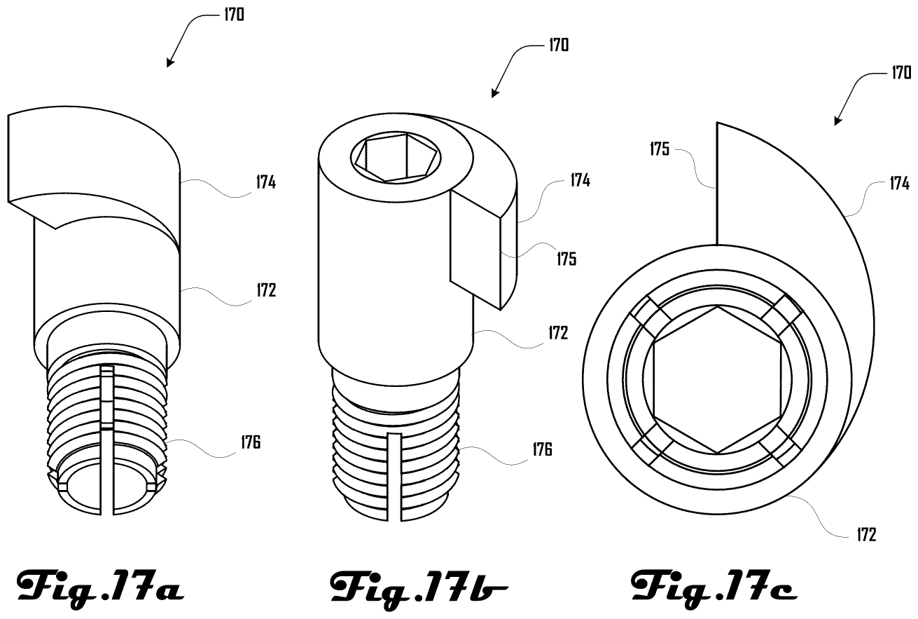

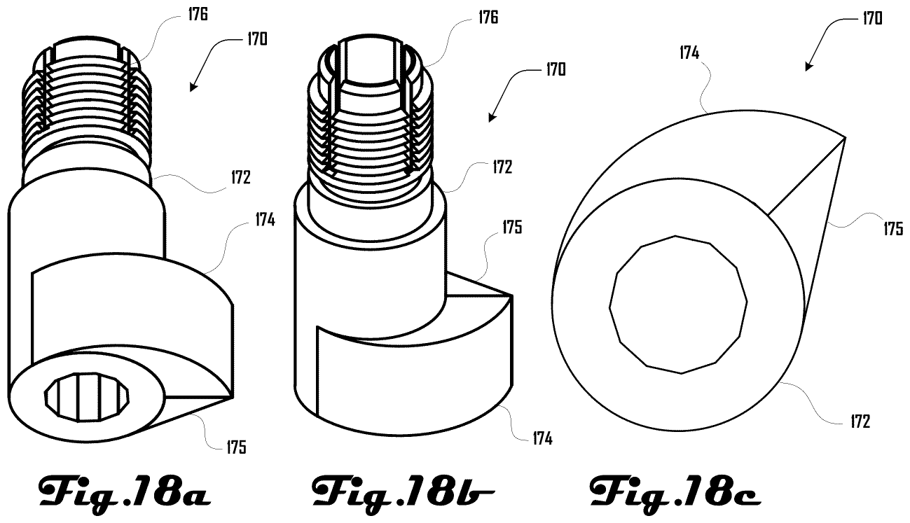

FIGS. 17a, 17b and 17c illustrate one example embodiment of a transmission 170 and FIGS. 18a, 18b and 18c illustrate another example embodiments of a transmission 170. As shown in these examples, a transmission 170 can comprise a transmission body 172 that includes a cam head 174 at a first end of the transmission body 172 and a driveshaft receiver 176 at a second end of the transmission body 172. In various embodiments, the transmission body 172 can comprise an elongated generally cylindrical shape. The cam head 174 in various examples can comprise an eccentric disc or portion thereof, with the eccentric disc being various suitable shapes such as a circle, oval, ovoid, irregular curved shape, or the like.

For example, FIGS. 17a, 17b and 17c illustrate an embodiment where the cam head 174 has a shape of a partial circle or ovoid with a planar face 175 that has an axis that is coincident with a central axis of the transmission body 172. FIGS. 18a, 18b and 18c illustrate an embodiment where the cam head 174 has a shape of a partial circle or ovoid with a planar face 175 that has an axis that is tangential to the transmission body 172.

The driveshaft receiver 176 can be configured to receive and hold a driveshaft 190, which in some embodiments can be via a collet nut 180 that screws onto driveshaft receiver 176 to pinch the driveshaft receiver 176 about an end 192 of a driveshaft 190. The driveshaft receiver 176 of the transmission 170 in some examples can feature a tube on the top end that is threaded on the outside with vertical slits and can act as a collet while the opposing end can act as a cam as discussed herein. The transmission 170 in various embodiments can fit into a receiver hole in a frame of a vibrato bridge assembly 105 that held an original arm assembly that various embodiments herein are configured to replace.

In various embodiments, a male spline of the driveshaft 190 fits into a female spline in the transmission 170. On the top side of the transmission 170, in various examples, a knurled collet nut 180 screws onto the threads of the transmission 170. When tightened, the collet nut 180 in some embodiments can apply force to a driveshaft receiver 176 (e.g., collet) of the transmission 170. The driveshaft receiver 176 (e.g., collet) can apply force to the driveshaft 190 in various examples to keep the driveshaft 190 in place. Simultaneously, in various embodiments, the bottom of the collet nut 180 applies force to a top side of a frame of the vibrato bridge assembly 105 to maintain an amount of rotational slip of the transmission from the frame of the vibrato bridge assembly 105. Once the collet nut 180 is tightened to force the driveshaft receiver 176 (e.g., collet) around the driveshaft 190, in various examples, no additional force can be added to the frame vibrato bridge assembly 105 by the collet nut 180. To further adjust this amount of force on the frame of the vibrato bridge assembly 105, some embodiments can include one or more (e.g., low-friction) washers on the shaft of the transmission 170 (e.g., of different thicknesses) placed above and/or below the frame of the vibrato bridge assembly 105, which in various examples can fine tune the amount of rotational slip of the transmission 170 to the desired feel or for any other suitable, necessary or desirable purpose.

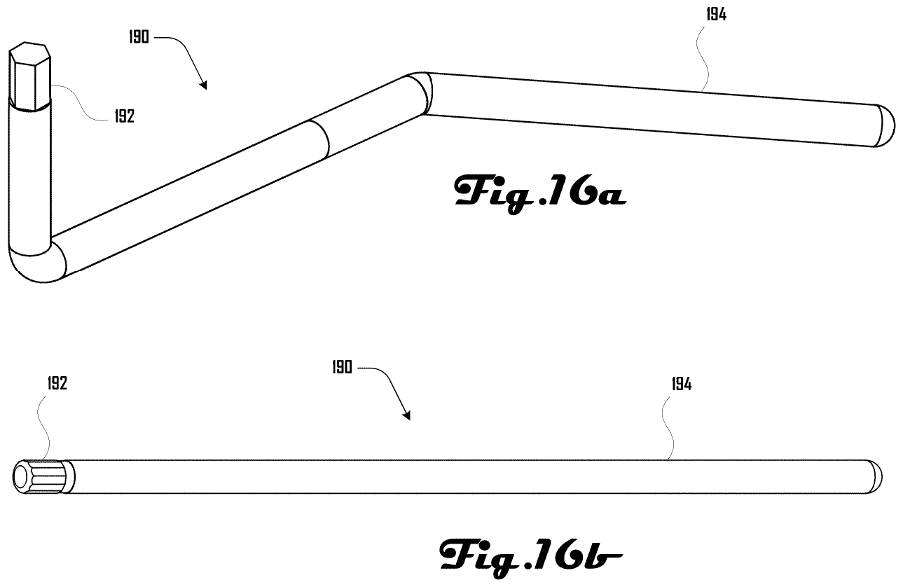

Example embodiments of a driveshaft 190 are shown in FIGS. 16a and 16b including a driveshaft 190 with a bent driveshaft body 194 in FIG. 16a and a driveshaft 190 with a linear body 194 in FIG. 16b. Further embodiments can include an elongated driveshaft 190 of various suitable shapes. A driveshaft 190 can be made from a rod in some examples. One end of the rod in some embodiments can be radiused for finish and/or the other end can have a male spline. The male spline can be inserted into the top of the transmission 170 in various embodiments. Additionally, while a driveshaft body 194 can have a cylindrical cross-section, further embodiments can have any suitable cross-section shape(s) or can be any suitable shape that provides for at least the functionalities discussed herein.

Turning to FIGS. 1, 2, 3a, 3b, 4a, 4b, 5a, 5b, 6a, 6b, 6c and 6d, example embodiments of a vibrato tailpiece system 101 are illustrated in various configurations including locked/unlocked configurations or on/off configurations. In various embodiments, a central axis of the transmission 170 can be parallel to a central axis of the block 110 and perpendicular to a main axis of the latch assembly 130 (e.g., a main axis of one or both of a latch 140 and latch base 150). The transmission 170 can be rotatably disposed adjacent to the second side 114 of the block 110 such that the cam head 174 engages the side bolt 123 of the block 110. In various embodiments, rotating the driveshaft 190 can rotate the transmission about a central axis of the transmission, such that the cam head 174 engages the side bolt 123 in different configurations such that rotation of the driveshaft 190 causes the cam head 174 to depress and release the side bolt 123 based on the radius of the cam head 174 engaging the side bolt.

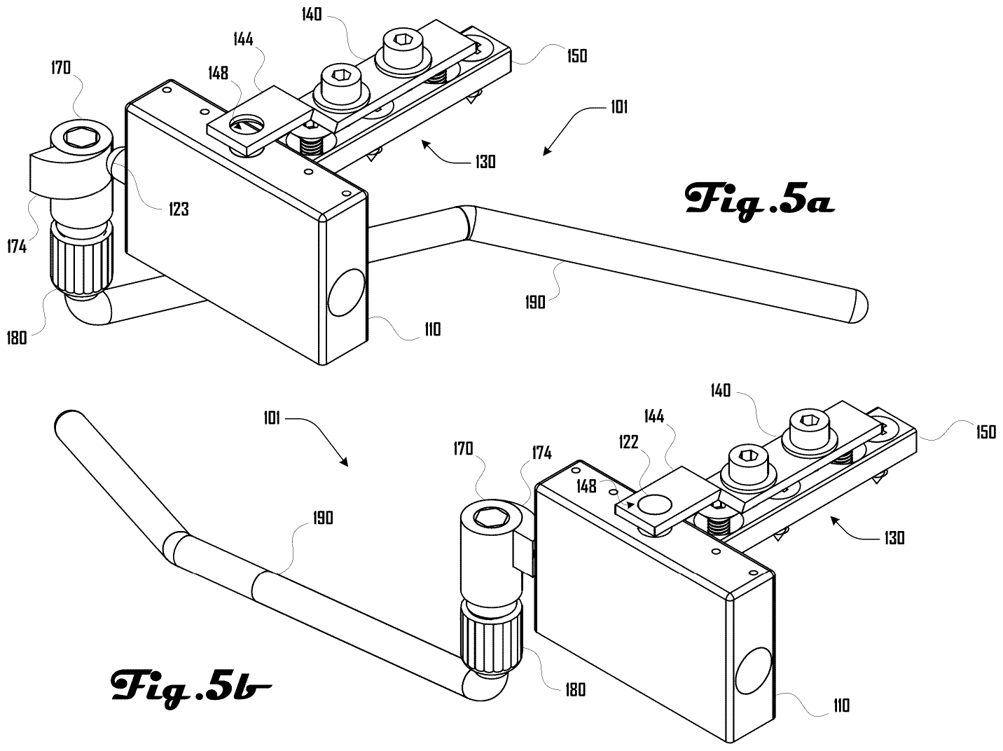

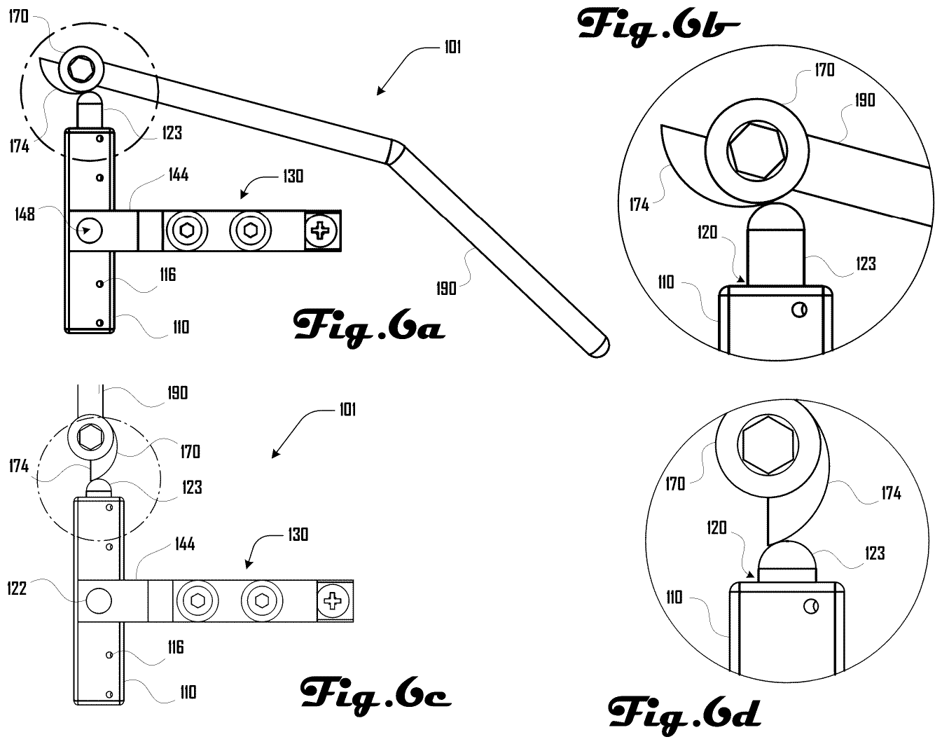

For example, FIGS. 5a, 6a and 6b illustrate an example of the driveshaft 190 in a first configuration such that the cam head 174 engages the side bolt 123 at or near a minimum radius of the cam head 174 such that the side bolt 123 extends from the side bolt opening 120 of the block 110 at or near a maximum length. In contrast, FIGS. 5b, 6c and 6d illustrate an example of the driveshaft 190 in a second configuration such that the cam head 174 engages the side bolt 123 at or near a maximum radius of the cam head 174 such that the side bolt 123 is depressed into the side bolt opening 120 of the block 110 at or near a minimum length.

Depressing the side bolt 123 into the side bolt opening 120 of the block 110 can cause the side bolt 123 to engage the side bolt bearing 125 within the block cavity 121, which in turn causes the side bolt bearing 125 to engage the top bolt bearing 124, which in turn causes the top bolt bearing 124 to engage the top bolt 122 such that the top bolt 122 extends out of the block cavity 121 via the top bolt opening 115. Depressing the top bolt 122 via the top bolt bearing 124 can compress the top bolt spring 126. Such a configuration is shown in the example of FIG. 12.

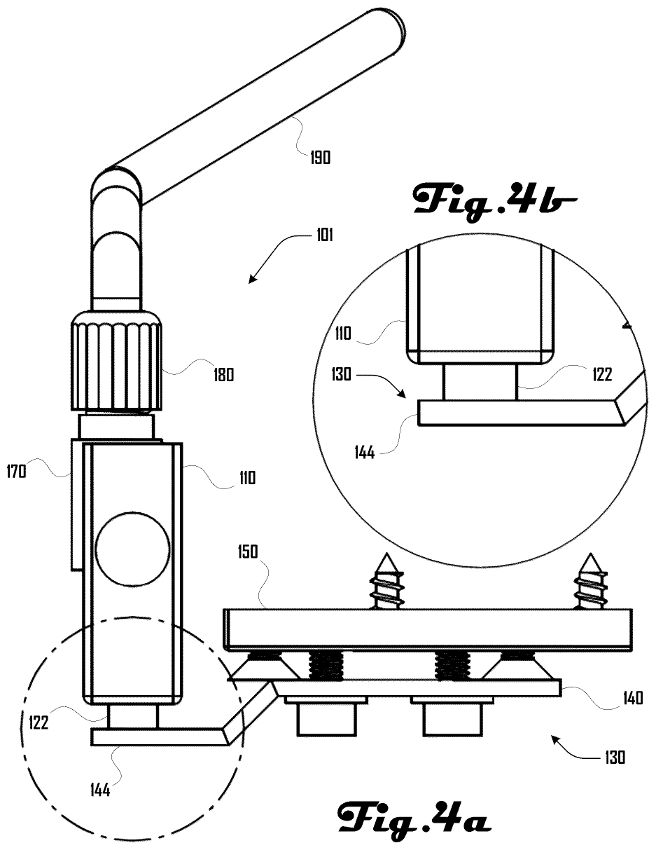

FIGS. 4a, 4b, 5b, 11a and 11b illustrate example configurations where the top bolt 122 extends from the top end 111 of the block 110 via the top bolt opening 115 and engages the receiver end 144 of the latch 140. In various embodiments, the top bolt 122 can extend within and/or engage with a coupling hole 148 defined by the receiver end 144 of the latch 140.

In various embodiments, such an engagement between the top bolt 122 and the latch 140 can cause the vibrato tailpiece system 101 to lock and/or disable a vibrato effect generated by the springs 107 (see FIG. 2) based on the springs 107 extending between the block 110 and claw 108. For example, such an engagement between the top bolt 122 and the latch 140 can prevent vibration or movement of the block 110 based on the top end 111 of the block 110 being immobilized or held via the engagement between the top bolt 122 and the latch 140.

To unlock or enable the vibrato effect, the driveshaft 190 can be rotated in reverse to cause the transmission 170 to rotate about a central axis, which can cause the cam head 174 to rotate such that the cam head 174 rotates toward a configuration where the cam head 174 engages the side bolt 123 at a minimum radius (e.g., as shown in FIGS. 5b, 6a, 6b). Such a rotation of the driveshaft 190, transmission 170 and cam head 174 can cause the top bolt to fully or at least partially retract into the block 110 via the top bolt opening 115.

For example, referring to FIG. 12, rotating the driveshaft 190 to cause the cam head 174 to rotate toward a configuration where the cam head 174 engages the side bolt 123 at a minimum radius can cause the biased top bolt 122 to fully or at least partially retract into the block cavity 121 via the top bolt opening 115 based on the biasing from the top bolt spring 126, which can apply pressure to the top bolt bearing 124, which in turn applies pressure to the side bolt bearing 125, which in turn applies pressure to the side bolt 123. The pressure applied to the side bolt can cause it to extend from the side bolt hole 120 as the cam head 174 rotates toward a configuration where the cam head 174 engages the side bolt 123 at a minimum radius.

Accordingly, in various embodiments, biasing of the top bolt 122 via the top bolt spring 126 can effectively bias the side bolt 123 via the bearings 124, 125 and cause the side bolt 123 to automatically extend out of the side bolt hole 120 and bear against the cam head 174. Such a configuration can thereby allow rotation of the transmission 170 and cam head 174 via the driveshaft 190 to cause the top bolt 122 to extend from and retract into the cavity 121 of the block 110. For example, rotation of the driveshaft 190 can cause the top bolt 122 to assume a retracted configuration such as shown in FIGS. 3a, 3b, 5a and 6a and to assume an extended configuration as shown in FIGS. 4a, 4b, 5b, 6a.

As the floating vibrato tailpiece system 101 is being used to adjust the pitch of the strings of the guitar 100, in various embodiments, the driveshaft 190 can be in an “OFF” position to do so, and the cam head 174 under the frame of the vibrato bridge assembly 105 can be in a neutral position relative to the side bolt 123. This position in various embodiments can allow for a fully operational, unencumbered floating vibrato tailpiece system 101. Rotating the arm/driveshaft 190 to an “ON” position, also rotates the cam head 174 of the transmission 170 to engage the side bolt 123 of the block assembly 110 of various embodiments. The “ON” position in some examples changes the state of the guitar 100 into a fixed-bridge system (e.g., FIGS. 4a, 4b, 5b, 6c, 6d).

The side bolt 123 extends when “OFF” in various embodiments. As the transmission 170 rotates, in various examples, the cam head 174 pushes the side bolt 123 into the block 110. The exposed side bolt 123 in some examples can comprise a 6 mm diameter×10.86 mm long rod with a radiused end to reduce friction as it slides on the surface of the cam head 174. In various embodiments, the side bolt 123 fits through a 6.1 mm side bolt hole 120 that travels for 2 mm deep, then sharply transitions to 9.1 mm inside the block (see e.g., FIG. 12). In the “ON” position of various embodiments, the cam head 174 can no longer rotate because of the restricted travel of the side bolt 123.

In some embodiments, rotational range of the arm/driveshaft 190 can be limited to 50°, 55°, 60°, 65°, 70°, 75°, 80°, 85°, 90°, 95°, 100°, 105°, 110°, 115°, 120°, 125°, 130°, 135°, 140°, 145°, 150°, or the like or a range between such example values. In various examples, a stock system's arm can rotate 360°; for example, some Bigsby systems can have a range of <360°.

In various embodiments, an unexposed part of the side bolt 123 can be disposed in the cavity 121 of the block 110 and can be 9 mm in diameter and 10.65 mm long with a flat end. The entire length of the side bolt 123 can be 21.51 mm in some examples. The flat end in various embodiments can push a (e.g., 9 mm) side bolt bearing 125 to its full throw in the “ON” position until it is stopped by a restriction 127 in the (e.g., 9.1 mm) shaft protruding from the bottom plug 117. In the “OFF” position of various embodiments, travel of the side bolt 123 can be restricted in the opposite direction by a shoulder that can be created on the side bolt 123 when sharply transitioning (e.g., from 6 mm diameter to 9 mm diameter). Such a shoulder in some examples rests on an inside wall that defines the cavity 121, which in some examples can be created by a 2 mm deep, 6.1 mm diameter hole sharp transition to 9.1 mm.

In the “ON” position, in various embodiments the side bolt bearing 125 can be pushed to its restricted travel while simultaneously pushing a (e.g., 7.5 mm) top bolt bearing 124 at a 90° angle in some examples, or other suitable angle in some examples. As the top bolt bearing 124 is being pushed by the side bolt bearing 125, in some examples, the top bolt bearing 124 travels in a (e.g., 7.6 mm) shaft of the cavity 121. The (e.g., 7.5 mm) top bolt bearing 124 can contact the (e.g., 7.5 mm diameter) top bolt 122. The rod shape of some embodiments of the top bolt 122 (e.g., of 7.5 mm diameter) can continue (e.g., for 2 mm) where shape diameter of the top bolt 122 can change (e.g., changes to 6 mm). The overall length of the top bolt 122 can be 12.68 mm in some examples. The top bolt 122 in various embodiments can be fitted with a spring 126 (e.g., with a 9.5 mm long×6.37 mm inner diameter×7.49 mm outer diameter spring, or the like). The (e.g., 7.5 mm) top bolt bearing 124, top bolt 122 and/or spring 126 can travel through a shaft (e.g., a 7.6 mm shaft) that is part of the cavity 121 in various embodiments. The shaft in some examples can sharply transition (e.g., to 6.1 mm and continues for 2 mm). In the “ON” position of various embodiments, the top bolt 122 extends (e.g., 5 mm) from the block 110 via the top bolt opening 115 where a flat end of the top bolt 122 fits into a latch 140.

In various embodiments, both the side bolt 123 and top bolt 122 can be housed in the cavity 121 of the block assembly 110 (e.g., FIG. 12). The block assembly 110 of some examples can be 50 mm×12 mm×32 mm and can range in different suitable dimensions in some examples to fit different clearance requirements for different instruments, or for other suitable purpose. The block assembly 110 of various embodiments can have the same basic shape of a stock vibrato tailpiece block that the block assembly 110 replaces. Accordingly, various embodiments can be configured for replacement of at least a portion of a stock vibrato tailpiece that is removed from a guitar 100; however, in some embodiments a block assembly 110 can be configured as a stock element of a guitar 100 instead of an after-market replacement piece.

The block assembly 110 of various embodiments bolts in the same fashion and/or position as a stock block that it replaces. For example, some embodiments of a block assembly can have three M5×8 mm mounting holes 118 on a 50 mm×12 mm bottom surface 112 opposite of a top surface 111. The top bolt 122 in some examples exits dead center of top surface 111 (e.g., 50 mm×12 mm surface). The side bolt hole 120 in some examples can be on a surface 114 (e.g., 32 mm×12 mm surface 13 mm from an edge of a 50 mm×12 mm surface) that contains one or more bolt holes (e.g., three M5×6 mm bolt holes). In various embodiments, an opposite surface 113 (e.g., 32 mm×12 mm surface) can be plain. The top surface 111 in some examples contains a plurality of spring holes 116 (e.g., four 1.5 mm×8 mm deep holes) that are angled (e.g., toward the left side) to hold one end of each counter-tension spring 107 (see e.g., FIG. 2). A counter-tension spring hole 116 in some examples is located 2.5 mm from each edge of a 32 mm×12 mm surface for the side bolt and plain side. A second counter-tension spring hole 116 in some examples can be 9 mm away from the edge hole for both sides. In various embodiments, some or all (e.g., four) counter-tension spring holes 116 are (e.g., 4 mm) inboard from the left side top edge in the width of the exit surface (e.g., 50 mm×11 mm top bolt exit surface). The top bolt 122 in various embodiments exits (e.g., dead center of) the top surface 111 (e.g., 50 mm×12 mm surface) and fits into a coupling hole 148 in the latch 140.

The top bolt 122 can extend within and/or engage a latch 140 in various suitable ways. For example, in some embodiments, the coupling hole 148 can have a chamfered or beveled edge, which can allow the top bolt 122 to extend within and engage the latch 140 without extending through the coupling hole 148. However, in some embodiments, coupling between the top bolt 122 and the coupling hole 148 can include the top bolt 122 extending through the coupling hole 148. Additionally, in some embodiments, a coupling hole 148 can be absent and engagement between the top bolt 122 and latch 140 can include the top bolt 122 engaging a planar surface of the latch 140, engaging a concave or convex portion of the latch 140, engaging a protrusion from the latch 140, or the like.

The latch 140 can be various suitable sizes (e.g., 50 mm×10 mm×2 mm) with a (e.g., 6.1 mm) radiused hole or countersink that receives an end of the top bolt 122. A receiver end 144 of the latch 140 can continue in length (e.g., for 18 mm) and then can have a bend (e.g., a 45° bend) toward the radiused side of the receiver hole, continues (e.g., for 5 mm) via a latch arm 146, then another bend (e.g., 45° bend) the opposite direction of the first bend, then continues flat via the latch bar 142. The latch 140 in some examples can also be a duplicate of the latch base 150 that is oriented in such a way as to allow the top bolt 122 to be captured into a coupling hole 148 (e.g., countersink). The latch 140 in various embodiments rests on top of one or more (e.g., two) height adjustment bolts 154 that screw into the latch base 150. The latch base 150 can be various suitable dimensions (e.g., 50 mm×10 mm×5 mm in dimension).

The latch in various embodiments can then be secured in place with one or more set bolts 156 (e.g., two set bolts) that go through the latch 140 and into the latch base 150. The set bolts 156 in various examples can apply force to the latch 140 and can press the latch 140 firmly against the top of the heads of the height adjustment bolts 154 The latch base 150 can be secured to the body of the guitar 100 in various suitable ways (e.g., with two wood screws). In various embodiments, the entire latch assembly 130 occupies the space where the center counter-tension spring 107 normally exists in a stock vibrato tailpiece assembly.

The example shapes and elements of the latch 140, coupling hole 148 and top bolt 122 should not be construed as limiting and any suitable shapes and elements can be used in some examples. Similarly, the side bolt 123 can be shaped in any suitable way in various embodiments. Additionally, as discussed herein, such elements can be construed differently for different styles of guitar for after-market replacement or for original installation.

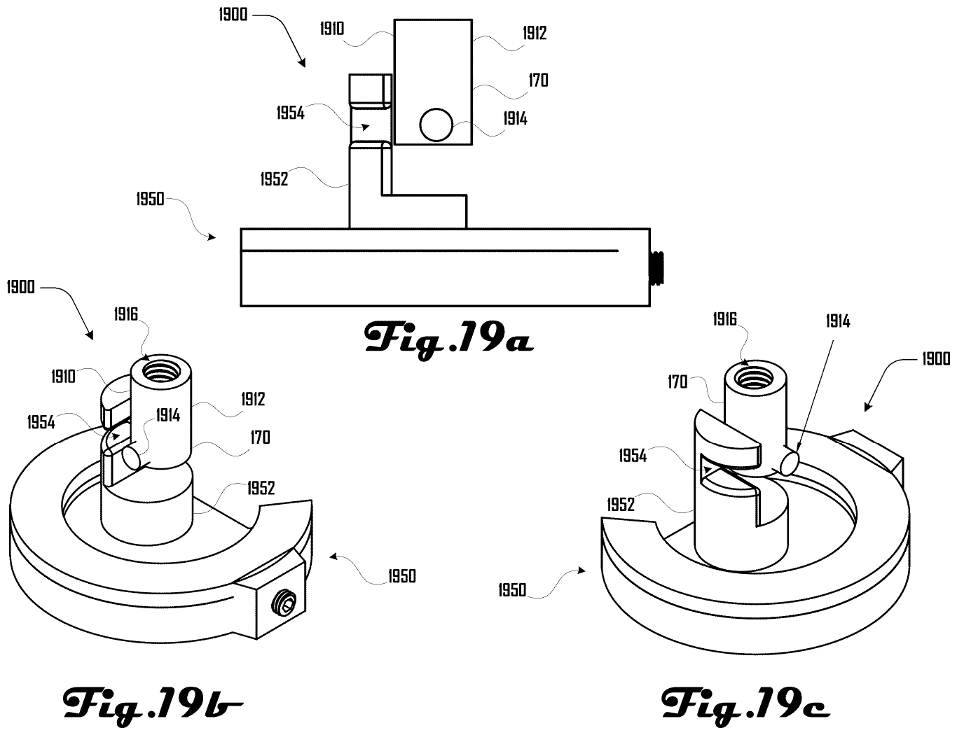

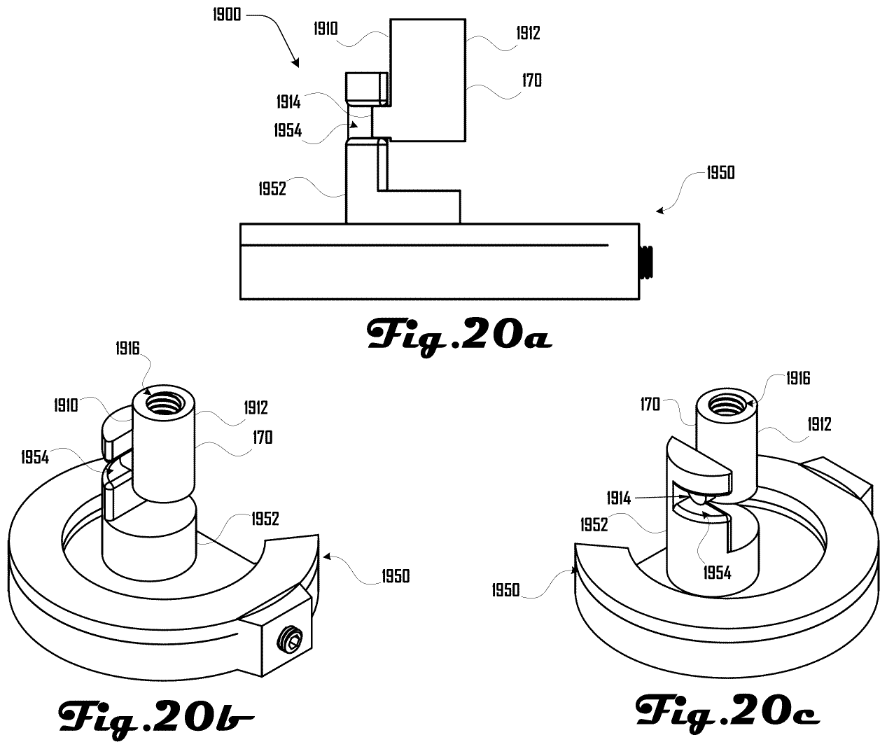

For example, as shown in FIGS. 19a-c and 20a-c, in some embodiments, a transmission 170 can be defined by a transmission bolt 1910 that comprises a cylindrical body 1912 that defines a coupling tab 1914 and a driveshaft receiver 1916. The transmission 170 in this example embodiment can be configured to rotatably couple with a base unit 1950 that includes an elongated slot body 1952 that defines a slot 1954. In various embodiments, the transmission bolt 1910 can be configured to rotate via a driveshaft 190 to cause the coupling tab 1914 to enter and be held within the slot 1954 and to rotatably cause the coupling tab 1914 to pass out of the slot 1954. For example, FIGS. 19a, 19b and 19c illustrate the transmission bolt 1910 in an “OFF” position where the coupling tab 1914 is outside of the slot 1954. In contrast, FIGS. 20a, 20b and 20c illustrate the transmission bolt 1910 in an “ON” position where the coupling tab 1914 has been rotated into the slot 1954 such that the coupling tab 1914 is held within the slot 1954.

In various embodiments, the engagement of the coupling tab 1914 within the slot 1954 can generate a similar functionality as a top bolt 122 coupling with a latch 140 as discussed herein.

As discussed herein, some embodiments can be configured to replace an existing or stock vibrato tailpiece of a guitar. In various examples a Fender & Floyd Rose-style vibrato tailpiece assembly can comprise a base/frame, arm and arm receiver, fulcrum(s), saddles, block, springs and claw. In various embodiments, a Bigsby-style vibrato tailpiece assembly can comprise a base/frame, spring and arm.

The following provides a non-limiting example of an installation which may be applicable to Fender & Floyd Rose guitars, or the like. For example, begin by ensuring that the guitar's stock vibrato tailpiece is properly adjusted and properly tuned. “X” must or can equal “Y” where “Z” is at origin. Remove the strings and counter-tension springs 107. Remove the stock tailpiece assembly from the guitar 100. Remove the arm and arm receiver assembly from the tailpiece assembly frame. Remove the saddles from the frame. Remove the bolts that secure the stock block to the bottom of the frame. Replace the stock block with a replacement system block assembly 110 oriented with a side bolt 123 of the block assembly 110 toward the hole in the frame of the bridge assembly 105 that held the original arm receiver assembly. Secure the new block assembly 110 firmly (e.g., with three new bolts included with a replacement system kit). Slide a (e.g., low-friction) washer around the collet end of the transmission 170. Insert the driveshaft receiver 176 (e.g., collet end) of the transmission 170 into the hole from the bottom that originally held the original arm receiver assembly. Slide another (e.g., low-friction) washer onto the collet end 176 from the top side of the base/frame. Screw the collet nut 180 onto the driveshaft receiver 176 (e.g., collet) and leave it somewhat loose. Insert the driveshaft 190 into a hole of the driveshaft receiver 176 (e.g., collet). Rotate the transmission 170 where the cam head 174 begins to touch the side bolt 123 of the block assembly 110. Orient the driveshaft body 194 of the driveshaft 190 into the position where the driveshaft body 194 is normally used and align the male splines 192 with the female receiver at the bottom of the driveshaft receiver 176 (e.g., transmission hole). Tighten the collet nut 180. Inspect that the desired amount of rotational slip of the driveshaft 190 and transmission 170 is correct. If too tight, change the (e.g., low-friction) washers to a thinner size, if too loose, change to a thicker size of washer (s.) In various embodiments a replacement system kit can comprise a plurality of washers of different thicknesses to accommodate different sizes and/or configurations of guitar systems being modified and/or replaced. Re-install the saddles onto the base/frame. Re-install the tailpiece assembly to the guitar. Re-install the counter-tension springs 107 and strings. Properly tune the guitar to its original tuning. “X” can or must equal “Y” where “Z” is at origin. Some embodiments can include a (e.g., slight) difference in architecture of the replacement block 110 vs. the original stock block, which in some examples, can require or make desirable adjustments to the claw 108 that holds the counter-tension springs 107 and/or the number of counter-tension springs 107 needs or is desirable to change. If a counter-tension spring 107 is located in the center position, move it to another available position. In various embodiments, a spring 107 in the center position cannot be present. For example, in various embodiments the latch assembly 130 occupies this space.

With the replacement block 110, transmission 170 and driveshaft 190 installed, and the guitar 100 is properly tuned where “X”=“Y” where “Z” is at origin, in various embodiments, now the latch assembly 130 can be adjusted before it can be installed.

Screw in (e.g., two) height adjustment bolts 154 into the latch base 150. Set the latch 140 on top of the latch base 150 oriented where the two holes 141 align with the two bolt holes 157 for securing the latch into place. Insert the (e.g., two) bolts 156 with washer(s) and secure the latch 140 to the latch base 150. Position the latch assembly 130 in the center location that the center counter-tension spring 107 would occupy flat on the floor of the back cavity 106 of the guitar 100. In various examples, the or a goal in various embodiments can be to position the receiver bolt hole 148 directly above the top bolt 122 with the proper height to accept a fully extended top bolt 122. Turn the driveshaft 190 to engage the replacement system to (e.g., fully) extend the top bolt 122. Fit the receiver bolt hole 148 onto the extended top bolt 122. In various embodiments, the surface end of the top bolt 122 should or can fully penetrate the thickness of the latch 140 (e.g., 2 mm) and should or can be flush with the visible side of the latch 140 or is captured into a countersink of the latch. In various examples, if the latch assembly 130 is no longer sitting flat on the floor of the guitar cavity 106, readjust the height bolts 154, re-secure the latch 140 to the latch base 150 and fit the top bolt 122 into the coupling hole 148 or countersink again. In various examples, the goal can be to adjust and secure the height of the latch 140 to the latch base 150 that allows for the latch base 150 to sit flush against the floor of the cavity 106, the latch 140 to be level with the latch base 150 and/or the top bolt 122 to fully penetrate the thickness of the latch 140 with the surface of the top bolt 122 being flush with the visible surface of the latch 140 or be captured into a countersink without moving the floating vibrato tailpiece system 101 or otherwise suitably coupling between the extended top bolt 122 and latch 140. Being careful not to allow the latch assembly 130 to move out of position, mark the floor of the guitar cavity 106 around the perimeter of the latch base 150. Remove the two bolts 156 that secure the latch 140 in place and leave the height adjustment bolts 154 un-altered. Re-position the latch base 150 within the perimeter markings. Mark the screw hole(s). Drill pilot holes for the screw(s) 152 (e.g., two wood screws). Screw the latch base 150 to the guitar via the one or more screws 152. Re-assemble the latch assembly 130, re-adjust the height adjustment bolts 154 (if necessary) and secure the latch 140 in place to allow for the bolt hole 148 and end surface of the top bolt 122 position as before.

It should be clear that the example method(s) disclosed above should not be construed to be limiting and the method steps are simply provided as an example in accordance with one or more embodiments. For example, one or more steps above can be applicable to replacing an existing stock system on a stock guitar body; initial installation of a system on a stock guitar body; initial installation on a custom guitar body; or the like.

The following provides a non-limiting example of an installation which may be applicable to guitars fitted with Bigsby vibrato systems, or the like. To begin, remove the strings and counter-tension spring. Remove the Bigsby nut and replace with a replacement transmission bolt 1910 (see e.g., FIGS. 19a-c and 20a-c) and washer(s). The transmission bolt 1910 can or should tighten into the position where the coupling tab 1914 is pointing toward the guitar's neck when arm is being used for vibrato. To adjust this, add or remove washer(s). Next, set the remaining assembly on top of the lower flange of the Bigsby assembly (e.g., Exhibit X item 29). Tighten the worm screw in the side of the base assembly firmly. Replace counter-tension spring and move the arm to turn the replacement system “ON”. Re-string and tune guitar. Fine-tuning the system: When the replacement system is turned “OFF,” take note of the general pitch of the strings. Did they go sharp? If so, in some examples a shim may need to be added to the transmission bolt 1910. Did they go flat? If so, in some examples a shim may need to be removed from the transmission bolt 1910.

As far as the professionals on stage in big venues go, there is typically a row of guitars on the side stage ready to go. Some are there for a change of scenery or sound, but the most important ones are there in case a string breaks during a performance. If a guitarist has a guitar equipped with various embodiments of a fixed-bridge system, when a string breaks, in various examples they can still continue playing the guitar on a limited basis. Because in various embodiments the rest of the strings still remain properly tuned or substantially properly tuned, a guitarist can make a judgment call in the moment whether they need to have their technician bring out another guitar right away or just wait until the end of the song. Even if they want it changed right away, they can choose to continue playing their part until the very moment that the guitar is switched out.

The semi or non-professional player, that does not have a guitar technician on the side stage on standby, that is playing a guitar with various embodiments of a fixed-bridge system will most commonly play their guitar with the handicap of a missing string until the end of the song. A good player can always make it sound like everything is normal. Most of the audience will not even notice that they broke a string.

Whether it is the professional or non-professional player performing live, if the guitar that is being used is a floating vibrato tailpiece and it breaks a string, it is unusable (e.g., immediately and unexpectedly). Every remaining string is out of tune. The guitar must be immediately switched. What if the guitarist that just broke a string with a floating vibrato tailpiece happens to be the lead singer, too? The only guitarist with no backing keyboard player? The guitar must be changed and the artistic moment dissolves, the audience is confused, the guitarist panics, the stage vibe suffers. Momentum is lost. As far as live performance is concerned, this is the worst yet likely outcome of this scenario.

With various embodiments of the novel vibrato tailpiece system 101 disclosed herein, the guitarist can engage the switch and flip it “ON” at their fingertips and find or wait for the best place to switch out instruments; perhaps an upcoming bridge or break in the song itself or at the end of the song. Even for the full arena setting with a side stage full of backup guitars ready to go, in the moment that a strings breaks, the professional can at least switch the novel vibrato tailpiece system 101 “ON” with their fingertips and continue playing their part until the technician becomes aware of the broken string (e.g., 3-5 seconds), turns to grab the backup guitar (e.g., another 3-5 seconds), runs out to the guitarist (e.g., 3-5 seconds), removes the guitar with the broken string and dresses the guitarist with the backup guitar (e.g., 5 seconds). Without the various embodiments of a novel vibrato tailpiece system 101 disclosed herein, it is realistically up to 20 seconds of “dead airtime” in various examples. With various embodiments of the novel vibrato tailpiece system 101 disclosed herein, the dead airtime of at most 5 seconds is the same as a fixed-bridge guitar broken string swap out and this time can be less in some examples.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

Also, the drawing exhibits herein should not be construed to be limiting and only as example embodiments of the present disclosure. For example, uses of the term “invention” should be construed to mean “an embodiment” or “an embodiment of the present.” Also, it should be clear that specific scales, sizes, ratios, illustrated in the drawings or otherwise discussed herein, are merely examples that may be present in one example embodiment and are not limiting on the present disclosure.

What is claimed is:

1. A method of locking and unlocking a vibrato tailpiece assembly of a guitar, the method comprising:
disassembling at least a portion of a stock vibrato tailpiece assembly, including at least:
removing a plurality of tension springs from a guitar cavity defined by a rear portion of a body of the guitar, the tension springs extending between a stock block and a claw,
removing the stock block coupled within the guitar cavity, and
removing a stock driveshaft from a front portion of the guitar,
installing a replacement block assembly within the guitar cavity, the replacement block assembly comprising:
a cuboid body having a top, bottom, first side and second side, the cuboid body defining an L-shaped block cavity, a top bolt opening at the top and a side bolt opening at one of the first and second sides,
a biased top bolt disposed within the block cavity and configured to extend through the top bolt opening,
a side bolt disposed within the block cavity and configured to extend through the side bolt opening,
a top bolt bearing disposed within the block cavity and engaging the top bolt,
a side bolt bearing disposed within the block cavity and engaging the side bolt and engaging the top bolt bearing, and
a top bolt spring that biases the top bolt,
installing a latch assembly within the guitar cavity, the latch assembly comprising,
an elongated latch base coupled to the guitar within the guitar cavity via at least two screws, and
an elongated latch defining a coupling hole, the latch coupled to the latch base via at least one set bolt and the latch spaced apart from the latch base via at least one height adjustment bolt, the latch assembly being installed such that the top bolt of the block assembly engages the coupling hole of the latch when the block assembly is in an ON configuration,
installing a transmission within the guitar cavity, the transmission comprising an elongated body having a cam head at a first transmission end and a driveshaft receiver at a second transmission end, the transmission installed such that the cam head rotatably engages the side bolt,
installing a replacement driveshaft in the driveshaft receiver with the replacement driveshaft extending from the front portion of the guitar,
tightening a collet nut about the replacement driveshaft and the driveshaft receiver to couple the replacement driveshaft to the transmission,
re-installing one or more of the plurality of tension springs to extend between the block assembly and the claw,
rotating the replacement driveshaft to an ON configuration to cause the transmission to rotate, which causes the cam head of the transmission to depress the side bolt into the block assembly and against the side bolt bearing, which in turn presses the top bolt bearing against the top bolt to cause the top bolt to extend out of the block assembly and engage the coupling hole of the latch of the latch assembly to lock the vibrato tailpiece assembly of the guitar,
rotating the replacement driveshaft to an OFF configuration to cause the transmission to rotate, which causes the cam head to allow the side bolt of the block assembly to extend out of the block assembly in response to force generated by the top bolt spring pressing the top bolt against the top bolt bearing, which presses the side bolt bearing against the side bolt to cause the side bolt to extend out of the block assembly, the top bolt spring causing the top bolt to retract within the block assembly and disengage from the coupling hole of the latch to unlock the vibrato tailpiece assembly of the guitar.

2. The method of claim 1, wherein the cam head has a shape of a partial circle or ovoid with a planar face.

3. The method of claim 1, wherein the replacement driveshaft in an elongated cylindrical bar.

4. The method of claim 1, wherein the latch assembly is installed within the guitar cavity in location of where one of the tension springs was originally located, and wherein reinstalling the tension springs includes installing all but one of the tension springs due to the latch assembly being in a location where one of the tension springs would be located.

5. A method of locking and unlocking a vibrato tailpiece assembly of a guitar, the method comprising:
installing the vibrato tailpiece assembly on the guitar, the vibrato tailpiece assembly comprising:
a block assembly that includes:
a body that defines a block cavity, a top bolt opening at a top and a side bolt opening at a side,
a top bolt disposed within the block cavity and configured to extend through the top bolt opening,
a side bolt disposed within the block cavity and configured to extend through the side bolt opening,
a latch assembly comprising:
a latch base coupled to the guitar within a guitar cavity of the guitar, and
a latch coupled to the latch base,
a transmission comprising:
a cam head, and
a driveshaft receiver, the transmission installed such that the cam head rotatably engages the side bolt of the block assembly,
a driveshaft coupled to the transmission,
rotating the driveshaft to an ON configuration to cause the transmission to rotate, which causes the cam head of the transmission to depress the side bolt into the block assembly, which causes the top bolt to extend out of the block assembly and engage the latch of the latch assembly to lock the vibrato tailpiece assembly of the guitar; and
rotating the driveshaft to an OFF configuration to cause the transmission to rotate, which causes the cam head to allow the side bolt of the block assembly to extend out of the block assembly, which causes the top bolt to retract and to disengage from the latch to unlock the vibrato tailpiece assembly of the guitar.

6. The method of claim 1, further comprising:
disassembling at least a portion of a stock vibrato tailpiece assembly, including by at least:
removing a plurality of tension springs from the guitar cavity defined by a rear portion of a body of the guitar, the plurality of tension springs extending between a stock block and a claw, and
removing the stock block coupled within the guitar cavity,
installing the block assembly in place of the stock block, and
re-installing one or more of the tension springs to extend between the installed block and the claw.

7. The method of claim 5, wherein the latch defines a coupling hole, and wherein rotating the driveshaft to the ON configuration to cause the transmission to rotate, which causes the top bolt to extend out of the block assembly and engage the coupling hole of the latch assembly to lock the vibrato tailpiece assembly of the guitar.

8. The method of claim 5, wherein the block assembly further comprises:
a top bolt bearing disposed within the block cavity and engaging the top bolt, and
a side bolt bearing disposed within the block cavity and engaging the side bolt and engaging the top bolt bearing.

9. The method of claim 5, wherein the block assembly further comprises a top bolt spring that biases the top bolt.

10. A method of locking and unlocking a vibrato tailpiece assembly of a guitar, the method comprising:
rotating a driveshaft of the vibrato tailpiece assembly to an ON configuration to lock the vibrato tailpiece assembly of the guitar; and
rotating the driveshaft to an OFF configuration to unlock the vibrato tailpiece assembly of the guitar.

11. The method of claim 10, wherein the vibrato tailpiece assembly comprises:
a block assembly,
a latch assembly, and
a transmission.

12. The method of claim 11, wherein the block assembly includes:
a body that defines a block cavity,
a top bolt disposed within the block cavity, and
a side bolt disposed within the block cavity.

13. The method of claim 11, wherein the latch assembly comprises:
a latch base coupled to the guitar within a guitar cavity of the guitar, and
a latch coupled to the latch base.

14. The method of claim 11, wherein the transmission comprises:
a cam head, and
a driveshaft receiver that holds the driveshaft.

15. The method of claim 10, wherein rotating the driveshaft of the vibrato tailpiece assembly to the ON configuration causes a transmission to depress a side bolt into a block assembly, which causes a top bolt to extend out of the block assembly and engage a latch to lock the vibrato tailpiece assembly of the guitar.

16. The method of claim 10, wherein rotating the driveshaft to the OFF configuration causes a cam head to allow a side bolt of a block assembly to extend out of the block assembly, which causes a top bolt to retract and to disengage from a latch to unlock the vibrato tailpiece assembly of the guitar.

17. The method of claim 10, wherein locking the vibrato tailpiece assembly includes a bolt engaging a latch and wherein unlocking the vibrato tailpiece assembly includes the bolt disengaging from the latch.

18. The method of claim 17, wherein the latch defines a coupling hole, and wherein rotating the driveshaft to the ON configuration causes the bolt to engage the coupling hole of the latch to lock the vibrato tailpiece assembly of the guitar.

19. The method of claim 10, further comprising:
disassembling at least a portion of a stock vibrato tailpiece assembly, including by at least removing a stock block, the stock block being inoperable to generate the ON configuration and configured to generate the OFF configuration, and
installing a block assembly in place of the stock block, the block assembly configured to generate the ON configuration and configured to generate the OFF configuration.

20. The method of claim 10, further comprising:
removing a plurality of tension springs from a guitar cavity defined by a body of the guitar, the plurality of tension springs extending between a stock block and a claw, and
installing on or more portions of the vibrato tailpiece assembly,
re-installing less than all of the plurality of tension springs due to one or more portions of the vibrato tailpiece assembly occupying a space where at least one of the plurality of tension springs was originally installed.
